(19) United States
(12) Patent Application Publication
(10) Pub. No.: US 2014/0116702 A1
(43) Pub. Date: May 1, 2014

(54) Expanded Wellbore Servicing Materials and Methods of Making and Using Same

(71) Applicant: HALLIBURTON ENERGY SERVICES, INC., Houston, TX (US)

(72) Inventor: Tingji TANG, Spring, TX (US)

(73) Assignee: HALLIBURTON ENERGY SERVICES, INC., Houston, TX (US)

(21) Appl. No.: 13/662,105

(22) Filed: Oct. 26, 2012

(51) Int. Cl. E21B 33/13; C08L 67/04; C08G 63/08

(52) U.S. Cl. 166/295; 521/182

(57) ABSTRACT

A method of servicing a wellbore in a subterranean formation comprising placing a first wellbore servicing fluid comprising an expanded diverting material into the wellbore allowing the expanded diverting material to form a diverter plug diverting the flow of a second wellbore servicing fluid to a different portion of the wellbore; and removing the diverter plug. A method of servicing a wellbore in a subterranean formation comprising placing a wellbore servicing fluid into the subterranean formation at a first location; plugging the first location with a expanded diverting material such that all or a portion of the wellbore servicing fluid is diverted to a second location in the subterranean formation; placing the wellbore servicing fluid into the subterranean formation at the second location; and allowing the expanded diverting material to degrade to provide a flowpath from the subterranean formation to the wellbore for recovery of resources from the subterranean formation.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Field

This disclosure relates to methods of servicing a wellbore. More specifically, it relates to methods of servicing a wellbore with expanded materials.

2. Background

Natural resources (e.g., oil or gas) residing in the subterranean formation may be recovered by driving resources from the formation into the wellbore using, for example, a pressure gradient that exists between the formation and the wellbore, the force of gravity, displacement of the resources from the formation using a pump or the force of another fluid injected into the well or an adjacent well. The production of fluid in the formation may be increased by hydraulically fracturing the formation. That is, a viscous fracturing fluid may be pumped down the wellbore at a rate and a pressure sufficient to form fractures that extend into the formation, providing additional pathways through which the oil or gas can flow to the well.

Unfortunately, water rather than oil or gas may eventually be produced by the formation through the fractures therein. To provide for the production of more oil or gas, a fracturing fluid may again be pumped into the formation to form additional fractures therein. However, the previously used fractures first must be plugged to prevent the loss of the fracturing fluid into the formation via those fractures.

Diverting materials are typically introduced into the wellbore and surrounding formation during fracturing and completion operations in order to provide a temporary plug for already fractured zones. While the diverter plugs are in effect, the formation may be subjected to another wellbore servicing operation (e.g., fracturing). However, upon finalization of the wellbore servicing operation, the diverting materials may need to be degraded to restore the flow of fluid (e.g., oil or gas) for collection.

Diverting materials which work by forming a physical barrier to flow may include perforation ball sealers and particulate diverting materials. Most commercially available ball sealers are either a solid material or will have a solid, rigid core comprising materials that are stable under downhole conditions, and thus, following a wellbore servicing operation, need to be recovered from the wellbore or otherwise removed from the treatment interval. This clean-up activity delays, complicates and adds expense to the well treatment process. An additional limitation of the use of perforation ball sealers is that they are may only be applicable in cased, perforated well bores; they are not applicable to other well completion scenarios such as open hole or with a slotted liner.

Particulate diverting materials often are suspended or dissolved in a carrier fluid until that fluid is saturated with the agents and excess material exists, and this fluid is introduced to the subterranean formation during the stimulation treatment. Traditional examples of particulate diverting materials are inorganic materials such as rock salts and polymeric materials such as starch and polyesters, etc. The particulate diverting materials typically form a seal in the subterranean formation (e.g., by packing off perforation tunnels, plating off a formation surface, plating off a hole behind a slotted liner, or packing along the surface of a hydraulic fracture), causing the treatment fluid to be diverted uniformly to other portions of the formation. If nondegradable diverting materials are used, subsequent wellbore servicing operations are typically carried out to remove the materials from the perforation tunnels or hole so as to allow the maximum flow of produced fluids that comprise hydrocarbons from the subterranean zone to flow into the well bore.

An ongoing need exists for degradable diverting materials that can be easily removed subsequent to performing their intended function.

### SUMMARY

Disclosed herein is a method of servicing a wellbore in a subterranean formation comprising placing a first wellbore servicing fluid comprising an expanded diverting material into the wellbore allowing the expanded diverting material to form a diverter plug diverting the flow of a second wellbore servicing fluid to a different portion of the wellbore; and removing the diverter plug.

Also disclosed is a wellbore servicing fluid comprising a diverting material comprising an expanded polylactide.

Further disclosed herein is a method of servicing a wellbore in a subterranean formation comprising placing a wellbore servicing fluid into the subterranean formation at a first location; plugging the first location with a expanded diverting material such that all or a portion of the wellbore servicing fluid is diverted to a second location in the subterranean formation; placing the wellbore servicing fluid into the subterranean formation at the second location; and allowing the expanded diverting material to degrade to provide a flowpath from the subterranean formation to the wellbore for recovery of resources from the subterranean formation.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a scanning electron microscopy micrograph of a polylactic acid foam.

FIG. 2 is a plot of diverter materials degradation over time.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques below, including the exemplary designs and implementations illustrated and described herein, but may be modified within the scope of the appended claims along with their full scope of equivalents.

Disclosed herein are wellbore servicing fluids or compositions comprising an expanded diverting material (EDM). In an embodiment, a diverting material may comprise any material suitable for distribution within or into a flowpath (e.g., a subterranean flowpath) so as to form a pack, a bridge, a plug or a filter cake and thereby cause fluid movement via that flowpath to cease or be reduced within a wellbore and/or surrounding formation. In an embodiment, the EDM may be configured to reduce the fluid flow via a given flowpath (i.e., reduce the fluid permeability at a point of entry for fluids into the formation) such that fluid movement is diverted (e.g., redirected) to another flowpath within the wellbore and/or formation.

In an embodiment, the EDM is a foamed material, it is to be understood that in the various embodiments referencing an EDM a foamed material may be employed in such embodiments. In an embodiment, the EDM comprises any substance compatible with the other components of the wellbore servicing fluid and that is formed by trapping pockets of gas in a liquid or solid. In an embodiment the EDM comprises an open-cell structure foam which herein refers to a low porosity, low density foam typically containing pores that are connected to each other. In an embodiment, the EDM comprises a closed cell-structure foam which herein refers to a foam characterized by pores which are not connected to each other and has a higher density and compressive strength when compared to open-cell structure foams. In an embodiment, the EDM is refers to a foamed particulate material in contrast to a foamed fluid which is prepared by entrapment of a gas into a liquid.

In an embodiment, the EDM is comprised of a naturally-occurring material. Alternatively, the EDM comprises a synthetic material. Alternatively, the EDM comprises a mixture of a naturally-occurring and synthetic material.

In an embodiment, the EDM comprises a degradable material that may undergo irreversible degradation downhole. As used herein “degradation” refers to conversion of the material into simpler compounds that do not retain all the characteristics of the starting material. The terms “degradation” or “degradable” may refer to either or both of heterogeneous degradation (or bulk erosion) and/or homogeneous degradation (or surface erosion), and/or to any stage of degradation in between these two. Not intending to be bound by theory, degradation may be a result of, inter alia, an external stimuli (e.g., heat, temperature, pH, etc.). As used herein, the term “irreversible” means that the degradable material, once degraded downhole, should not recrystallize or reconsolidate while downhole.

In an embodiment, the EDM comprises a degradable polymer. Herein the disclosure may refer to a polymer and/or a polymeric material. It is to be understood that the terms polymer and/or polymeric material herein are used interchangeably and are meant to each refer to compositions comprising at least one polymerized monomer in the presence or absence of other additives traditionally included in such materials. Examples of degradable polymers suitable for use as the degradable material include, but are not limited to homopolymers, random, block, graft, star- and hyper-branched aliphatic polyesters, copolymers thereof, derivatives thereof, or combinations thereof. The term “derivative” herein is defined to include any compound that is made from one or more of the compounds comprising the degradable material, for example, by replacing one atom in the compound with another atom or group of atoms, rearranging two or more atoms in the compound, ionizing the compound, or creating a salt of the compound. The term “copolymer” as used herein is not limited to the combination of two polymers, but includes any combination of any number of polymers, e.g., graft polymers, terpolymers and the like. In an embodiment, the degradable polymer comprises polysaccharides; lignosulfonates; chitins; chitosans; proteins; proteinous materials; fatty alcohols; fatty esters; fatty acid salts; aliphatic polyesters; poly(lactides); poly(glycolides); poly(ε-caprolactones); polyoxymethylene; polyurethanes; poly(hydroxybutyrates); poly(anhydrides); aliphatic polycarbonates; polyvinyl polymers; acrylic-based polymers; poly(amino acids); poly(aspartic acid); poly(alkylene oxides); poly(ethylene oxides); polyphosphazenes; poly(orthoesters); poly(hydroxy ester ethers); polyether esters; polyester amides; polyamides; polyhydroxyalkanoates; polyethyleneterephthalates; polybutyleneterephthalates; polyethylenenaphthalenates, and copolymers, blends, derivatives, or combinations thereof. In an embodiment, the EDM comprises BIOFOAM. BIOFOAM is a biodegradable plant-based foam commercially available from Synbra. In an embodiment, the degradable polymer comprises solid cyclic dimers, or solid polymers of organic acids. Alternatively, the degradable polymer comprises substituted or unsubstituted lactides, glycolides, polylactic acid (PLA), polyglycolic acid (PGA), copolymers of PLA and PGA, copolymers of glycolic acid with other hydroxy-, carboxylic acid-, or hydroxycarboxylic acid-containing moieties, copolymers of lactic acid with other hydroxy-, carboxylic acid-, or hydroxycarboxylic acid-containing moieties, or combinations thereof.

In an embodiment, the degradable polymer comprises an aliphatic polyester which may be represented by the general formula of repeating units shown in Formula I:

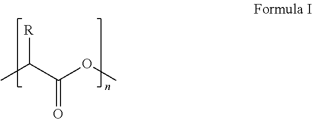

where n is an integer with a value ranging from about 75 to about 10,000, alternatively from about 100 to about 5000, or alternatively from about 200 to about 2000, and R comprises hydrogen, an alkyl group, an aryl group, alkylaryl groups, acetyl groups, heteroatoms, or combinations thereof.

In an embodiment, the aliphatic polyester comprises poly(lactic acid) or polylactide (PLA). Because both lactic acid and lactide can achieve the same repeating unit, the general term poly(lactic acid), as used herein, refers to Formula I without any limitation as to how the polymer was formed (e.g., from lactides, lactic acid, or oligomers) and without reference to the degree of polymerization or level of plasticization.

Also, as will be understood by one of ordinary skill in the art, the lactide monomer may exist, generally, in one of three different forms: two stereoisomers L- and D-lactide and racemic D,L-lactide (meso-lactide). The oligomers of lactic acid, and oligomers of lactide suitable for use in the present disclosure may be represented by general Formula II:

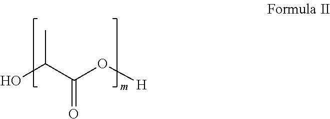

where m is an integer with a value ranging from greater than or equal to 2 to less than or equal to 75 or alternatively from greater than or equal to 2 to less than or equal to 10. In such an embodiment, the molecular weight of the PLA may be less than about 5,400 g/mole, alternatively, less than about 720 g/mole, respectively. The stereoisomers of lactic acid may be used individually or combined to be used in accordance with the present disclosure.

In an additional embodiment, the degradable polymer comprises a copolymer of lactic acid. A copolymer of lactic acid may be formed by copolymerizing one or more stereoisomers of lactic acid with, for example, glycolide, ε-caprolactone, 1,5-dioxepan-2-one, or trimethylene carbonate, so as to obtain polymers with different physical and/or mechanical properties that are also suitable for use in the present disclosure. In an embodiment, degradable polymers suitable for use in the present disclosure are formed by blending, copolymerizing or otherwise mixing the stereoisomers of lactic acid. Alternatively, degradable polymers suitable for use in the present disclosure are formed by blending, copolymerizing or otherwise mixing high and/or low molecular weight polylactides. Alternatively, degradable polymers suitable for use in the present disclosure are formed by blending, copolymerizing or otherwise mixing polylactide with other polyesters. In an embodiment, the degradable polymer comprises PLA which may be synthesized using any suitable methodology. For example, PLA may be synthesized either from lactic acid by a condensation reaction or by a ring-opening polymerization of a cyclic lactide monomer. Methodologies for the preparation of PLA are described in U.S. Pat. Nos. 6,323,307; 5,216,050; 4,387,769; 3,912,692; and 2,703,316, each of which is incorporated by reference herein in its entirety. Additional descriptions of degradable polymers suitable for use in the present disclosure may be found in the publication of Advances in Polymer Science, Vol. 157 entitled “Degradable Aliphatic Polyesters” edited by A. C. Albertsson, which is incorporated herein in its entirety.

In an embodiment, the degradable polymer comprises a polyanhydride. Examples of polyanhydrides suitable for use in the present disclosure include, but are not limited to, poly(adipic anhydride), poly(suberic anhydride), poly(sebacic anhydride), poly(dodecanedioic anhydride), poly(maleic anhydride), poly(benzoic anhydride), or combinations thereof.

In an embodiment, the degradable polymer comprises polysaccharides, such as starches, cellulose, dextran, substituted or unsubstituted galactomannans, guar gums, high-molecular weight polysaccharides composed of mannose and galactose sugars, heteropolysaccharides obtained by the fermentation of starch-derived sugar (e.g., xanthan gum), diutan, scleroglucan, derivatives thereof, or combinations thereof.

In an embodiment, the degradable polymer comprises guar or a guar derivative. Nonlimiting examples of guar derivatives suitable for use in the present disclosure include hydroxypropyl guar, carboxymethylhydroxypropyl guar, carboxymethyl guar, hydrophobically modified guars, guar-containing compounds, synthetic polymers, or combinations thereof.

In an embodiment, the degradable polymer comprises cellulose or a cellulose derivative. Nonlimiting examples of cellulose derivatives suitable for use in the present disclosure include cellulose ethers, carboxycelluloses, carboxyalkylhydroxyethyl celluloses, hydroxyethylcellulose, hydroxypropylcellulose, carboxymethylhydroxyethylcellulose, carboxymethylcellulose, or combinations thereof.

In an embodiment, the degradable polymer comprises a starch. Nonlimiting examples of starches suitable for use in the present disclosure include native starches, reclaimed starches, waxy starches, modified starches, pre-gelatinized starches, or combinations thereof.

In an embodiment, the degradable polymer comprises polyvinyl polymers, such as polyvinyl alcohols, polyvinyl acetate, partially hydrolyzed polyvinyl acetate, or combinations thereof.

In an embodiment, the degradable polymer comprises acrylic-based polymers, such as acrylic acid polymers, acrylamide polymers, acrylic acid-acrylamide copolymers, acrylic acid-methacrylamide copolymers, polyacrylamides, polymethacrylamides, partially hydrolyzed polyacrylamides, partially hydrolyzed polymethacrylamides, ammonium and alkali metal salts thereof, or combinations thereof.

In an embodiment, the degradable polymer comprises polyamides, such as polycaprolactam derivatives, poly-paraphenylene terephthalamide or combinations thereof. In an embodiment, the degradable polymer comprises nylon 6, 6; nylon 6; KEVLAR aramid fiber, or combinations thereof. KEVLAR aramid fiber is a para-aramid synthetic fiber commercially available from Dupont.

The physical properties associated with the degradable polymer may depend upon several factors including, but not limited to, the composition of the repeating units, flexibility of the polymer chain, the presence or absence of polar groups, polymer molecular mass, the degree of branching, polymer crystallinity, polymer orientation, and the like. For example, a polymer having substantial short chain branching may exhibit reduced crystallinity while a polymer having substantial long chain branching may exhibit for example, a lower melt viscosity and impart, inter alia, elongational viscosity with tension-stiffening behavior. The properties of the degradable polymer may be further tailored to meet some user and/or process designated goal using any suitable methodology such as blending and/or copolymerizing the degradable polymer with another polymer, or by changing the macromolecular architecture of the degradable polymer (e.g., hyper-branched polymers, star-shaped, or dendrimers, etc.).

In an embodiment, in choosing the appropriate degradable polymer, an operator may consider the degradation products that will result. For example, an operator may choose the degradable polymer such that the resulting degradation products do not adversely affect one or more other operations, treatment components, the formation, or combinations thereof. Additionally, the choice of degradable polymer may also depend, at least in part, upon the conditions of the well.

Nonlimiting examples of additional degradable polymers suitable for use in conjunction with the methods of this disclosure are described in more detail in U.S. Pat. Nos. 7,565,929 and 8,109,335, and U.S. Patent Publication Nos. 20100273685 A1, 20110005761 A1, 20110056684 A1 and 20110227254 A1, each of which is incorporated by reference herein in its entirety.

In an embodiment, the degradable polymer further comprises a plasticizer. The plasticizer may be present in an amount sufficient to provide one or more desired characteristics, for example, (a) more effective compatibilization of the melt blend components, (b) improved processing characteristics during the blending and processing steps, (c) control and regulation of the sensitivity and degradation of the polymer by moisture, (d) control and/or adjustment of one or more properties of the foam (e.g., strength, stiffness, etc.), or combinations thereof. Plasticizers suitable for use in the present disclosure include, but are not limited to, derivatives of oligomeric lactic acid, such as those represented by the formula:

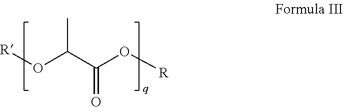

where R and/or R′ are each a hydrogen, an alkyl group, an aryl group, an alkylaryl group, an acetyl group, a heteroatom, or combinations thereof provided that R and R′ cannot both be hydrogen and that both R and R′ are saturated; q is an integer where the value of q ranges from greater than or equal to 2 to less than or equal to 75 or alternatively from greater than or equal to 2 to less than or equal to 10. As used herein the term “derivatives of oligomeric lactic acid” may include derivatives of oligomeric lactide. In an embodiment where a plasticizer of the type disclosed herein is used, the plasticizer may be intimately incorporated within the degradable polymeric materials.

In an embodiment, the EDM comprises one or more components of BIOVERT NWB diverting agent, BIOVERT CF diverting agents, BIOVERT H150 diverter and fluid loss control material or combinations thereof. BIOVERT NWB diverting agent is a near-wellbore biodegradable diverting agent; BIOVERT H150 diverter and fluid loss control material and BIOVERT CF is a complex fracture biodegradable diverting agent; each of which is commercially available from Halliburton Energy Services.

EDMs may prepared by foaming degradable materials of the type described herein. The degradable materials may be foamed using any suitable methodology compatible with the methods of the present disclosure. Methods of foaming materials of the type disclosed herein (e.g., degradable polymers) include without limitation gas foaming, chemical agent foaming, injection molding, compression molding, extrusion molding, extrusion, melt extrusion, pressure reduction/vacuum induction, or any suitable combination of these methods.

In an embodiment, the EDM may be prepared from a composition comprising a polymer and a foaming agent. The polymer may be of the type described previously herein (e.g., polystyrene, polyethylene, polyurethane, polyamide, polylactide). The foaming agent may be any foaming agent compatible with the other components of the EDM such as for example physical blowing agents, chemical blowing agents, and the like.

In an embodiment, the foaming agent is a physical blowing agent. Physical blowing agents are typically nonflammable gases that are able to evacuate the composition quickly after the foam is formed. Examples of physical blowing agents include without limitation pentane, carbon dioxide, nitrogen, water vapor, propane, n-butane, isobutane, n-pentane, 2,3-dimethylpropane, 1-pentene, cyclopentene, n-hexane, 2-methylpentane, 3-methylpentane, 2,3-dimethylbutane, 1-hexene, cyclohexane, n-heptane, 2-methylhexane, 2,2-dimethylpentane, 2,3-dimethylpentane, and combinations thereof. In an embodiment, the physical blowing agent is incorporated into the polymeric composition in an amount of from about 0.1 wt. % to about 10 wt. %, alternatively from about 0.1 wt. % to about 5.0 wt. %, or alternatively from about 0.5 wt. % to about 2.5 wt. %, wherein the weight percent is based on the total weight of the polymeric composition (e.g., degradable material).

In an embodiment, the foaming agent is a chemical foaming agent, which may also be referred to as a chemical blowing agent. A chemical foaming agent is a chemical compound that decomposes endothermically at elevated temperatures. A chemical foaming agent suitable for use in this disclosure may decompose at temperatures of from about 250° F. to about 570° F., alternatively from about 330° F. to about 400° F. Decomposition of the chemical foaming agent generates gases that become entrained in the polymer thus leading to the formation of voids within the polymer. In an embodiment, a chemical foaming agent suitable for use in this disclosure may have a total gas evolution of from about 20 ml/g to about 200 ml/g, alternatively from about 75 ml/g to about 150 ml/g, or alternatively from about 110 ml/g to about 130 ml/g. Examples of chemical foaming agents suitable for use in this disclosure include without limitation SAFOAM FP-20, SAFOAM FP-40, SAFOAM FPN3-40, all of which are commercially available from Reedy International Corporation. In an embodiment, the chemical foaming agent may be incorporated in the polymeric composition (e.g., degradable material) in an amount of from about 0.10 wt. % to about 5 wt. % by total weight of the polymeric composition (e.g., degradable material), alternatively from about 0.25 wt. % to about 2.5 wt. %, or alternatively from about 0.5 wt. % to about 2 wt. %.

In an embodiment, the EDM is prepared by contacting the degradable polymer with the foaming agent, and thoroughly mixing the components for example by compounding or extrusion. In an embodiment, the EDM is plasticized or melted by heating in an extruder and is contacted and mixed thoroughly with a foaming agent of the type disclosed herein at a temperature of less than about 500° F., alternatively less than about 400° F., alternatively less than about 300° F., or alternatively less than about 200° F. Alternatively, the degradable material may be contacted with the foaming agent prior to introduction of the mixture to the extruder (e.g., via bulk mixing), during the introduction of the polymer to an extruder, or combinations thereof. Methods for preparing an expanded polymer composition are described for example in U.S. Patent Publication Nos. 20090246501 A1, and U.S. Pat. Nos. 5,006,566 and 6,387,968, each of which is incorporated by reference herein in its entirety.

The EDMs of this disclosure may be converted to expanded particles by any suitable method. The expanded particles may be produced about concurrently with the mixing and/or foaming of the degradable materials (e.g., on a sequential, integrated process line) or may be produced subsequent to mixing and/or foaming of the degradable material (e.g., on a separate process line such as an end use compounding and/or thermoforming line). In an embodiment, the degradable material is mixed and expanded via extrusion as previously described herein, and the molten EDM is fed to a shaping process (e.g., mold, die, lay down bar, etc.) where the EDM is shaped. The foaming of the degradable material may occur prior to, during, or subsequent to the shaping. In an embodiment, molten degradable material is injected into a mold, where the degradable material undergoes foaming and fills the mold to form a shaped article (e.g., beads, block, sheet, and the like), which may be subjected to further processing steps (e.g., grinding, milling, shredding, etc.).

In an embodiment, the EDMs are further processed by mechanically sizing, cutting or, chopping the EDM into particles using any suitable methodology for such processes. The EDMs suitable for use in this disclosure comprise expanded particles of any suitable geometry, including without limitation beads, hollow beads, spheres, ovals, fibers, rods, pellets, platelets, disks, plates, ribbons, and the like, or combinations thereof.

In an embodiment, the porosity of an EDM suitable for use in this disclosure may range from about 20 volume percent (vol. %) to about 90 vol. %, alternatively from about 30 vol. % to about 70 vol. %, or alternatively from about 40 vol. % to about 50 vol. %. The porosity of a material is defined as the percentage of volume that the pores (i.e., voids, empty spaces) occupy based on the total volume of the material. The porosity of the EDM may be determined using a porosity tester such as the Foam Porosity Tester F0023 which is commercially available from IDM Instruments.

In an embodiment, the pore size of a EDM suitable for use in this disclosure may range from about 0.1 microns to about 5000 microns, alternatively from about 0.1 microns to about 500 microns, alternatively from about 5 microns to about 200 microns, or alternatively from about 10 microns to about 100 microns. The pore size of the material may be determined using any suitable methodology such as scanning electron microscopy, atomic force microscopy, or a porometer.

In an embodiment, the compressive strength of a EDM suitable for use in this disclosure may range from about 0.1 psi to about 1,000,000 psi, alternatively from about 100 psi to about 100,000 psi, or alternatively from about 1000 psi to about 10000 psi. The compressive strength of the material may be determined by UCS measurement.

In an embodiment, EDM particles suitable for use in conjunction with the methods of this disclosure comprise EDMs having a bulk density from about 0.05 g/cc to about 1 g/cc, alternatively from about 0.1 g/cc to about 0.5 g/cc, or alternatively from about 0.1 g/cc to about 0.6 g/cc as determined by densitometry.

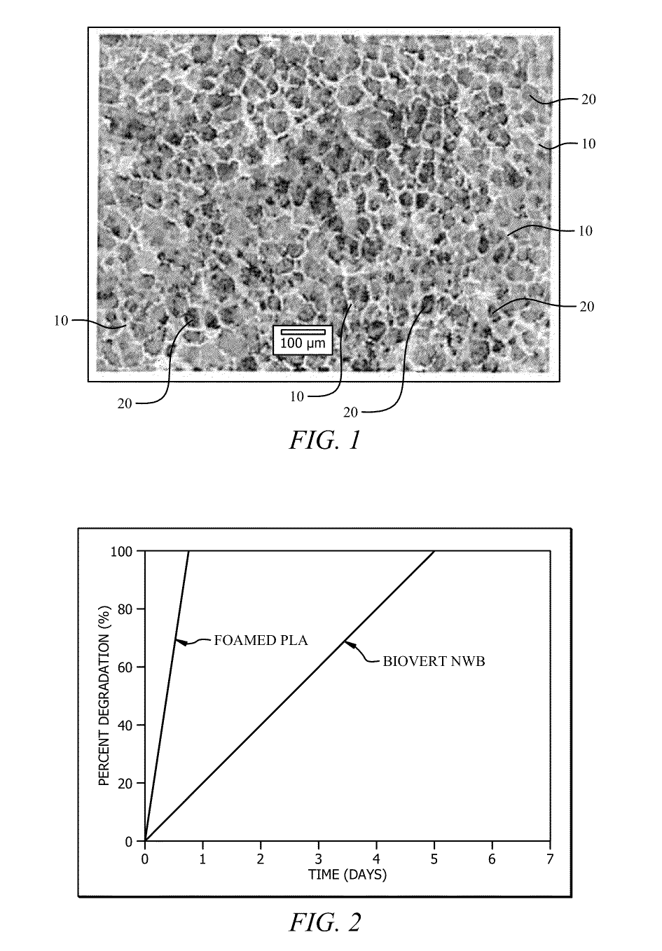

In an embodiment, the EDM comprises a foamed polylactic acid. FIG. 1 displays a scanning electron microscopy micrograph of a cross-section of a polylactic acid foam, wherein the polymeric material (i.e., polylactic acid 10) has been formed into a foam with voids (i.e., pores) 20. The EDM displayed in FIG. 1 was expanded using supercritical CO₂. The EDM may be further mechanically sized into EDM particulates having an average size of from about 1 μm to about 1 mm, by using any suitable methodology (e.g., cutting, chopping, and the like).

A EDM of the type disclosed herein may be included in any suitable wellbore servicing fluid. As used herein, a “servicing fluid” refers to a fluid used to drill, complete, work over, fracture, repair, or in any way prepare a wellbore for the recovery of materials residing in a subterranean formation penetrated by the wellbore. Examples of wellbore servicing fluids include, but are not limited to, cement slurries, drilling fluids or muds, spacer fluids, lost circulation fluids, fracturing fluids, diverting fluids or completion fluids. The servicing fluid is for use in a wellbore that penetrates a subterranean formation. It is to be understood that “subterranean formation” encompasses both areas below exposed earth and areas below earth covered by water such as ocean or fresh water. In an embodiment, the EDM may be present in a wellbore servicing fluid in an amount of from about 0.01 weight percent (wt. %) to about 10 wt. %, alternatively from about 0.1 wt. % to about 5 wt. %, or alternatively from about 0.1 wt. % to about 1 wt. % based on the total weight of the wellbore servicing fluid.

In an embodiment, the EDM is manufactured on-the-fly (e.g., in real time or on-location), as previously described herein. Alternatively, the EDM is manufactured off site and then the EDM may be transported to the well site for further use.

Alternatively, the EDM may be assembled and prepared as a slurry in the form of a liquid additive. In an embodiment, the EDM and a wellbore servicing fluid may be blended until the EDM particulates are distributed throughout the fluid. By way of example, the EDM particulates and a wellbore servicing fluid may be blended using a blender, a mixer, a stirrer, a jet mixing system, or other suitable device. In an embodiment, a recirculation system keeps the EDM particulates uniformly distributed throughout the wellbore servicing fluid. In an embodiment, the wellbore servicing fluid comprises water, and may comprise at least one dispersant blended with the EDM particulates and the water to reduce the volume of water required to suspend the EDM particulates. Examples of a suitable dispersants are FR-56 liquid friction reducer which is an oil-external emulsion, or HYDROPAC service which a water-based viscous gel system each of which are commercially available from Halliburton, Energy Services Inc.

When it is desirable to prepare a wellbore servicing fluid comprising an EDM of the type disclosed herein (i.e., a diverting fluid) for use in a wellbore, the diverting fluid prepared at the wellsite or previously transported to and, if necessary, stored at the on-site location may be combined with the EDM, additional water and optional other additives to form the diverting fluid. In an embodiment, additional diverting materials may be added to the diverting fluid on-the-fly along with the other components/additives. The resulting diverting fluid may be pumped downhole where it may function as intended.

In an embodiment, a concentrated EDM liquid additive is mixed with additional water to form a diluted liquid additive, which is subsequently added to a diverting fluid. The additional water may comprise fresh water, salt water such as an unsaturated aqueous salt solution or a saturated aqueous salt solution, or combinations thereof. In an embodiment, the liquid additive comprising the EDM is injected into a delivery pump being used to supply the additional water to a diverting fluid composition. As such, the water used to carry the EDM particulates and this additional water are both available to the diverting fluid such that the EDM may be dispersed throughout the diverting fluid.

In an alternative embodiment, the EDM prepared as a liquid additive is combined with a ready-to-use diverting fluid as the diverting fluid is being pumped into the wellbore. In such embodiments, the liquid additive may be injected into the suction of the pump. In such embodiments, the liquid additive can be added at a controlled rate to the diverting fluid (e.g., or a compound thereof such as blending water) using a continuous metering system (CMS) unit. The CMS unit can also be employed to control the rate at which the liquid additive is introduced to the diverting fluid or component thereof as well as the rate at which any other optional additives are introduced to the diverting fluid or component thereof. As such, the CMS unit can be used to achieve an accurate and precise ratio of water to EDM concentration in the diverting fluid such that the properties of the diverting fluid (e.g., density, viscosity), are suitable for the downhole conditions of the wellbore. The concentrations of the components in the diverting fluid, e.g., the EDMs, can be adjusted to their desired amounts before delivering the composition into the wellbore. Those concentrations thus are not limited to the original design specification of the diverting fluid and can be varied to account for changes in the downhole conditions of the wellbore that may occur before the composition is actually pumped into the wellbore.

In an embodiment, the wellbore servicing fluid comprises a composite treatment fluid. As used herein, the term “composite treatment fluid” generally refers to a treatment fluid comprising at least two component fluids. In such an embodiment, the two or more component fluids may be delivered into the wellbore separately via different flowpaths (e.g., such as via a flowbore, a wellbore tubular and/or via an annular space between the wellbore tubular and a wellbore wall/casing) and substantially intermingled or mixed within the wellbore (e.g., in situ) so as to form the composite treatment fluid. Composite treatment fluids are described in more detail in U.S. Patent Publication No. 20100044041 A1 which is incorporated by reference herein in its entirety.

In an embodiment, the composite treatment fluid comprises a diverting fluid (e.g., a wellbore servicing fluid comprising an EDM of the type disclosed herein). In such an embodiment, the diverting fluid is formed from a first component and a second component. For example, the first component may comprise a diverter-laden slurry (e.g., a concentrated diverter-laden slurry pumped via a tubular flowbore) and the second component may comprise a fluid with which the diverter-laden slurry may be mixed to yield the composite diverting fluid, that is, a diluent (e.g., an aqueous fluid, such as water pumped via an annulus). In an embodiment, the diverter-laden slurry comprises an EDM-laden slurry.

In an embodiment, the diverter-laden slurry (e.g., the first component) comprises a base fluid and diverting materials (e.g., an EDM of the type disclosed herein). In an embodiment, the base fluid may comprise a substantially aqueous fluid. As used herein, the term “substantially aqueous fluid” may refer to a fluid comprising less than about 25% by weight of a non-aqueous component, alternatively less than about 20% by weight, alternatively less than about 15% by weight, alternatively less than about 10% by weight, alternatively less than about 5% by weight, alternatively less than about 2.5% by weight, alternatively less than about 1.0% by weight of a non-aqueous component. Examples of suitable substantially aqueous fluids include, but are not limited to, water that is potable or non-potable, untreated water, partially treated water, treated water, produced water, city water, well-water, surface water, or combinations thereof. In an alternative or additional embodiment, the base fluid may comprise an aqueous gel, a viscoelastic surfactant gel, an oil gel, a foamed gel, an emulsion, an inverse emulsion, or combinations thereof.

In an embodiment, the diluent (e.g., the second component) may comprise a suitable aqueous fluid, aqueous gel, viscoelastic surfactant gel, oil gel, a foamed gel, emulsion, inverse emulsion, or combinations thereof. For example, the diluent may comprise one or more of the compositions disclosed above with reference to the base fluid. In an embodiment, the diluent may have a composition substantially similar to that of the base fluid; alternatively, the diluent may have a composition different from that of the base fluid.

In an embodiment, the size and/or shape of the diverting material may be chosen so as to provide a plug (e.g., filter cake) within a given flowpath (e.g., within a point of entry into the wellbore and/or at a given distance from the wellbore within a fracture) having a given size, shape, and/or orientation. In an embodiment, the EDM may be added to the wellbore servicing fluid to generate a diverting fluid which is then pumped downhole at the same time with additional diverting material. For near wellbore diversions, the EDM may be delivered to the zone of interest independent of the proppant although the particle size and/or particle size distribution of the EDM selected will be dependent on the proppant particle size and/or particle size distribution selected for the particular wellbore-servicing operation. In an embodiment, the selection of a suitable proppant particle size and/or particle size distribution is based on the self-limiting bridging theory. For near wellbore diversions, the EDM and proppant are placed downhole about concurrently and the particle and/or particle size distribution of the EDM is selected to be compatible with the particle size and/or particle size distribution of the proppant. In some embodiments where the EDM is utilized in a far-field diversion the particle size and/or particle size distribution of the EDM is comparable to the particle size and/or particle size-distribution of the proppant.

In an embodiment, the diverting fluid (e.g., wellbore servicing fluid comprising the EDM) may form a diverter plug within a given flowpath within the wellbore and/or formation, and thereby cause fluid movement via that flowpath to cease or be reduced. As such, movement of fluid via that flowpath may be diverted to another flowpath within the wellbore and/or formation, thereby treating another zone or formation for example and causing a fracture to be initiated or extended within another formation zone.

In an embodiment, as noted above, the EDM may be configured, for example, via selection of a given size and/or shape, for placement at a given position (e.g., at a given depth of the wellbore) within a flowpath. Without wishing to be limited by theory, where it is desired that a diverter plug forms in the near-wellbore region, the EDM may be selected so as to have a multimodal particle size distribution for example, from about 20 to about 25% of the material may have a particle size distribution ranging from about 4 to about 10 mesh; greater than about 50% of the material may have a particle size distribution ranging from about 20 to about 40 mesh with the remaining material having a particle size distribution of equal to or less than about 40 mesh. As used herein, the term “mesh size” is used to refer to the sizing of a particular screen as defined by as “ASTM E-11 Specifications” or “ISO 3310-1”. Generally, mesh size may refer approximately to the greatest size of material that will pass through a particular mesh size, for example, the nominal opening. The mesh size may also refer to the inside dimension of each opening in the mesh (e.g., the inside diameter of each square). Alternatively, where it is desired that a diverter plug forms in the far-wellbore region, the EDM may be selected so as to have a smaller particle size (e.g., less than about 100 mesh). The near-wellbore region delimitation is dependent upon the formation where the wellbore is located, and is based on the wellbore surrounding conditions. The far-wellbore region is different from the near-wellbore region in that it is subjected to an entirely different set of conditions and/or stimuli. In an embodiment, the near-wellbore and far-wellbore regions are based on the fracture length propagating away from the wellbore. In such embodiments, the near-wellbore region refers to about the first 20% of the fracture length propagating away from the wellbore (e.g., 50 feet) whereas the far-wellbore region refers to a length that is greater than about 20% of the fracture length propagating away from the wellbore (e.g., greater than about 50 feet). Again, without wishing to be limited by theory, smaller diverter particles may be carried a greater distance into the formation (e.g., into an existing and/or extending fracture).

A method of servicing a wellbore may comprise placing a wellbore servicing fluid (e.g., fracturing or other stimulation fluid such as an acidizing fluid) into a portion of a wellbore. In such embodiments, the fracturing or stimulation fluid may enter flow paths and perform its intended function of increasing the production of a desired resource from that portion of the wellbore. The level of production from the portion of the wellbore that has been stimulated may taper off over time such that stimulation of a different portion of the well is desirable. Additionally or alternatively, previously formed flowpaths may need to be temporarily plugged in order to fracture or stimulate additional/alternative intervals or zones during a given wellbore service or treatment. In an embodiment, an amount of a diverting fluid (e.g., wellbore servicing fluid comprising an EDM) sufficient to effect diversion of a wellbore servicing fluid from a first flowpath to a second flowpath is delivered to the wellbore. The diverting fluid may form a temporary plug, also known as a diverter plug or diverter cake, once disposed within the first flowpath which restricts entry of a wellbore servicing fluid (e.g., fracturing or stimulation fluid) into the first flowpath. The diverter plug may deposit onto the face of the formation and create a temporary skin that decreases the permeability of the zone. The wellbore servicing fluid restricted from entering the first flowpath may enter one or more additional flowpaths and perform its intended function. Within a first treatment stage, the process of introducing a wellbore servicing fluid into the formation to perform an intended function (e.g., fracturing or stimulation) and, thereafter, diverting the wellbore servicing fluid to another flowpath into the formation and/or to a different location or depth within a given flowpath may be continued until some user and/or process goal is obtained. In an additional embodiment, this diverting procedure may be repeated with respect to each of a second, third, fourth, fifth, sixth, or more, treatment stages, for example, as disclosed herein with respect to the first treatment stage.

In an embodiment, the wellbore service being performed is a fracturing operation, wherein a fracturing fluid was placed (e.g., pumped downhole) at a first location in the formation to form fractures that extend into the formation, providing additional pathways through which the oil or gas can flow to the well. Subsequent operations may be performed to alter the permeability of a second location and an EDM is employed to divert the fracturing fluid from the first location to a second location in the formation such that fracturing can be carried out at a plurality of locations. The EDM may be placed into the first (or any subsequent location) via pumping a slug of a diverter fluid (e.g., a fluid having a different composition than the fracturing fluid) containing the EDM and/or by adding the EDM directly to the fracturing fluid, for example to create a slug of fracturing fluid comprising the EDM. The EDM may form a diverter plug at the first location (and any subsequent location so treated) such that the fracturing fluid may be selectively placed at one or more additional locations, for example during a multi-stage fracturing operation. The EDM may be allowed to degrade, for example due to in situ wellbore conditions and/or upon contact with a degradation agent, such that flowpaths are provided from the formation into the wellbore for the recovery of resources (e.g., oil and gas) from the formation. The degradation may begin to occur while the fracturing operations are ongoing and/or completed, and may be controlled or timed such that degradation occur and/or reach completion according to a desired schedule (e.g., about concurrently with completion of fracturing operations and preparations to begin or continue production from the wellbore).

In an embodiment, EDMs of the type disclosed herein are placed into the wellbore concurrent with the placement of a proppant (e.g. sand). In such embodiments, the wellbore servicing operation may comprise a farfield diversion of the EDM and such operations may increase the complexity of the fracture geometry potentially increasing the productivity of the fractured zone.

In an embodiment, following a wellbore servicing operation utilizing a diverting fluid (e.g., a wellbore servicing fluid comprising an EDM), the wellbore and/or the subterranean formation may be prepared for production, for example, production of a hydrocarbon, therefrom.

In an embodiment, preparing the wellbore and/or formation for production may comprise removing an EDM (which has formed a temporary plug) from one or more flowpaths, for example, by allowing the diverting materials therein to degrade.

In an embodiment the EDM comprises a degradable polymer of the type previously disclosed herein, which degrades due to, inter alia, a chemical and/or radical process such as hydrolysis or oxidation or physical dissolution process such as that observed when expanded polyethylene (EPE) or expanded polypropylene (EPP) is contacted with crude oil. As may be appreciated by one of skill in the art upon viewing this disclosure, the degradability of a polymer may depend at least in part on its backbone structure. For example, the presence of hydrolyzable and/or oxidizable linkages within the backbone structure may yield a material that will degrade as described herein. As may also be appreciated by one of skill in the art upon viewing this disclosure, the rates at which such polymers degrade may be at least partially dependent upon polymer characteristics such as the type of repetitive unit, composition, sequence, length, molecular geometry, molecular weight, morphology (e.g., crystallinity, size of spherulites, and orientation), hydrophilicity, hydrophobicity, surface area, and type of additives. Additionally, the ambient downhole environment to which a given polymer is subjected may also influence how it degrades, (e.g., temperature, pressure, presence of moisture, oxygen, microorganisms, enzymes, pH, the like, and combinations thereof).

In an embodiment, the EDM comprises a degradable polymer having an enhanced surface area. Without wishing to be limited by theory, the larger the surface area exposed to a medium and/or environment in which the material undergoes a reaction (e.g., hydrolytic degradation), the shorter the reaction time frame will be for a fixed amount of material, while keeping all the other conditions unchanged (e.g., same pressure, same temperature, etc.). For example, if polymeric material A is a nonporous solid having a mass x and a surface area y, then the expanded material of this disclosure obtained from polymer A that has the same mass x, may have a surface area of 2y, 5y, 10y, 20y, 50y, or 100y. As a result of having a larger surface area, the expanded material may display faster degradation times. In an embodiment, the EDM displays a surface area that is increased with respect to the unexpanded material by a factor of about 50, alternatively by a factor of about 100, or alternatively by a factor of about 200.

In an embodiment the EDM comprises aliphatic polyesters of the type previously disclosed herein. In such an embodiment, the EDM may be degraded in the presence of an acid (e.g., in situ, downhole) or base catalyst via hydrolytic cleavage. Not intending to be bound by theory, during hydrolysis, carboxylic end groups are formed during chain scission and this may enhance the rate of further hydrolysis. This mechanism is termed “autocatalysis,” and is thought to make polyester matrices more bulk eroding.

In an embodiment, degradation of the EDM is a result of interaction of the EDM with a degradation agent. The type of degradation agent utilized will depend on the nature of the EDM. In an embodiment, degradation of the EDM may occur under ambient conditions as a result of the wellbore environment (e.g., temperature, pressure, pH, water content, etc.)

In an embodiment, the EDM is degraded (e.g., in situ, downhole) via hydrolytic or aminolytic degradation. In an embodiment, degradation of the EDM is carried out in the presence of an accelerator. Herein an accelerator refers to a material that increases the rate of degradation of the EDM. In an embodiment, the EDMs are provided within a portion of the subterranean formation with an accelerator. In an embodiment, the accelerator comprises a base solution such as an ammonium hydroxide solution, an alcoholic alkaline solution, an alkaline amine solution, or combinations thereof. Other examples of base solutions suitable for use as accelerators are described in more detail in U.S. Patent Publication No. 20100273685 A1, which is incorporated by reference herein in its entirety.

In an embodiment, the accelerator used for degradation of a EDM comprises water-soluble amines such as alkanolamines, secondary amines, tertiary amines, oligomers of aziridine, derivatives thereof, or combinations thereof. Non-limiting examples of water-soluble amines suitable for use in conjunction with the methods of this disclosure are described in more detail in U.S. patent application Ser. No. 13/660,740 filed Oct. 25, 2012 and entitled “Wellbore Servicing Methods and Compositions Comprising Degradable Polymers,” which is incorporated by reference herein in its entirety.

In an embodiment, the EDM (e.g., a degradable material) may be selected and/or otherwise configured such that the diverter will degrade (e.g., thereby re-establishing and/or improving fluid communication between the wellbore and the formation) within a desired and/or preselected time-range.

In an embodiment, the EDM when subjected to degradation conditions of the type disclosed herein (e.g., elevated temperatures and/or pressures) degrades in a time range of about 4 hours, alternatively about 6 hours, or alternatively about 12 hours. Alternatively, in another embodiment, EDMs of the type disclosed herein when subjected to a degradation agent substantially degrades in a time frame of less than about 1 week, alternatively less than about 2 days, or alternatively less than about 1 day.

In another embodiment, the EDM comprises a material which is characterized by the ability to be degraded at bottom hole temperatures (BHT) of less than about 220° F., alternatively less than about 180° F., or alternatively less than about 140° F.

In an embodiment, EDMs of the type disclosed herein may be advantageously used as diverting materials that have a shorter degradation time when compared to otherwise similar materials that have not been expanded. In an embodiment, EDMs of the type disclosed herein may be advantageously used as diverting materials that have a shorter degradation time when compared to otherwise identical materials that have not been expanded. The improved (i.e., shorter) degradation time of the EDM may be due to their larger surface area when compared to the same material that has not been expanded. In an embodiment, the EDM particles are advantageously more pliable (i.e., less stiff) when compared to the same materials that have not been expanded. As used herein, the term “pliable” refers to the ability of a material to sustain a shape deformation without losing its structural integrity. In an embodiment, the pliable EDMs may advantageously assist in the formation of a diverter plug or other plugging mass having improved fluid loss reduction and/or diverting characteristics when compared to a diverter cake formed from the same materials that have not been expanded. Further, due to increased surface area less of the EDM may be needed to achieve obstruction of the flowpaths.

Additionally, EDMs of the type disclosed herein may find utility in the treatment of loss circulation where they may be placed to obstruct areas or zones of high permeability. In particular, fluids may enter and be “lost” to the subterranean formation via depleted zones, zones of relatively low pressure, lost circulation zones having naturally occurring fractures, weak zones having fracture gradients exceeded by the hydrostatic pressure of the drilling fluid, and so forth. EDMs may be introduced to prevent the loss of fluids to these areas.

The following are additional enumerated embodiments of the concepts disclosed herein.

A first embodiment which is a method of servicing a wellbore in a subterranean formation comprising placing a first wellbore servicing fluid comprising an expanded diverting material into the wellbore; allowing the expanded diverting material to form a diverter plug; diverting the flow of a second wellbore servicing fluid to a different portion of the wellbore; and removing the diverter plug.

A second embodiment which is the method of the first embodiment wherein the expanded diverting material comprises a degradable or removable material.

A third embodiment which is the method of any of the first through second embodiments wherein the expanded material comprises an open-cell structure foam or a closed-cell structure foam.

A fourth embodiment which is the method of the second embodiment wherein the degradable material comprises a degradable polymer.

A fifth embodiment which is the method of the fourth embodiment wherein the degradable polymer comprises polysaccharides; lignosulfonates; chitins; chitosans; proteins; proteinous materials; fatty alcohols; fatty esters; fatty acid salts; aliphatic polyesters; poly(lactides); poly(glycolides); poly(ε-caprolactones); polyoxymethylene; polyurethanes; poly(hydroxybutyrates); poly(anhydrides); aliphatic polycarbonates; polyvinyl polymers; acrylic-based polymers; poly(amino acids); poly(aspartic acid); poly(alkylene oxides); poly(ethylene oxides); polyphosphazenes; poly(orthoesters); poly(hydroxy ester ethers); polyether esters; polyester amides; polyamides; polyhydroxyalkanoates; polyethyleneterephthalates; polybutyleneterephthalates; polyethylenenaphthalenates, or combinations thereof.

A sixth embodiment which is the method of the fifth embodiment wherein the aliphatic polyester comprises a compound represented by general formula I:

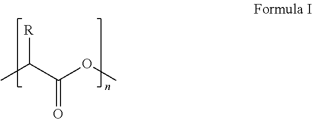

where n is an integer ranging from about 75 to about 10,000 and R comprises hydrogen, an alkyl group, an aryl group, alkylaryl groups, acetyl groups, heteroatoms, or combinations thereof.

A seventh embodiment which is the method of any of the fourth through sixth embodiments wherein the degradable polymer comprises polylactic acid.

An eighth embodiment which is the method of any of the first through seventh embodiments wherein the expanded diverting material has a porosity of from about 20 vol. % to about 90 vol. %.

A ninth embodiment which is the method of any of the first through eighth embodiments wherein the expanded diverting material has a particle size of from about 0.1 microns to about 5000 microns.

A tenth embodiment which is the method of any of the first through ninth embodiments wherein the compressive strength of the expanded diverting material ranges from about 0.1 psi to about 1,000,000 psi.

An eleventh embodiment which is the method of any of the first through tenth embodiments wherein the expanded diverting material has a bulk density of from about 0.05 g/cc to about 1 g/cc.

A twelfth embodiment which is the method of any of the first through eleventh embodiments wherein the expanded diverting material is present in the wellbore servicing fluid in an amount of from about 0.01 wt. % to about 10 wt. % based on the total weight of the wellbore servicing fluid.

A thirteenth embodiment which is the method of any of the first through twelfth embodiments wherein the second wellbore servicing fluid comprises a fracturing fluid.

A fourteenth embodiment which is the method of any of the first through thirteenth embodiments further comprising degrading the expanded diverting material.

A fifteenth embodiment which is the method of the fourteenth embodiment wherein the expanded diverting material is degraded by contact with a degradation agent.

A sixteenth embodiment which is the method of the fifteenth embodiment wherein the degradation agent comprises a base solution, an ammonium hydroxide solution, an alcoholic alkaline solution, an alkaline amine solution, a water-soluble amine, an alkanolamine, a secondary amine, a tertiary amine, oligomers of aziridine, derivatives thereof, or combinations thereof.

A seventeenth embodiment which is a wellbore servicing fluid comprising a diverting material comprising an expanded polylactide.

An eighteenth embodiment which is the wellbore servicing fluid of the seventeenth embodiment wherein the expanded polylactide is contacted with a degradation agent comprising an alkaline amine solution.

A nineteenth embodiment which is a method of servicing a wellbore in a subterranean formation comprising placing a wellbore servicing fluid into the subterranean formation at a first location; plugging the first location with an expanded diverting material such that all or a portion of the wellbore servicing fluid is diverted to a second location in the subterranean formation; placing the wellbore servicing fluid into the subterranean formation at the second location; and allowing the expanded diverting material to degrade to provide a flowpath from the subterranean formation to the wellbore for recovery of resources from the subterranean formation.

A twentieth embodiment which is the method of the nineteenth embodiment wherein the wellbore servicing fluid is a fracturing fluid and the subterranean formation is fractured thereby at the first and second locations.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

The properties of an expanded diverting material comprising a degradable polymer were investigated. More specifically, the degradation of polylactic acid both as a foam and as a solid (i.e., with no pores) was monitored over time at a constant temperature of 220° F., and the results are displayed in FIG. 2. PLA at a concentration of 1 lb/gallon of tap water was placed in a glass bottle. Periodically the solid materials were removed from the bottle, dried and weighed at the indicated time periods. For the solid polylactic acid, BIOVERT NWB diverting agent was used. As it can be seen from FIG. 2, solid BIOVERT NWB diverting agent displayed 100% degradation after 5 days, while expanded PLA completely degraded in less than 1 day under the same conditions.

While embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the embodiments of the present invention. The discussion of a reference in the Description of Related Art is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A method of servicing a wellbore in a subterranean formation comprising;
placing a first wellbore servicing fluid comprising an expanded diverting material into the wellbore;
allowing the expanded diverting material to form a diverter plug;
diverting the flow of a second wellbore servicing fluid to a different portion of the wellbore; and
removing the diverter plug.

2. The method of claim 1 wherein the expanded diverting material comprises a degradable or removable material.

3. The method of claim 1 wherein the expanded material comprises an open-cell structure foam or a closed-cell structure foam.

4. The method of claim 2 wherein the degradable material comprises a degradable polymer.

5. The method of claim 4 wherein the degradable polymer comprises polysaccharides; lignosulfonates; chitins; chitosans; proteins; proteinous materials; fatty alcohols; fatty esters; fatty acid salts; aliphatic polyesters; poly(lactides); poly(glycolides); poly(ε-caprolactones); polyoxymethylene; polyurethanes; poly(hydroxybutyrates); poly(anhydrides); aliphatic polycarbonates; polyvinyl polymers; acrylic-based polymers; poly(amino acids); poly(aspartic acid); poly(alkylene oxides); poly(ethylene oxides); polyphosphazenes; poly(orthoesters); poly(hydroxy ester ethers); polyether esters; polyester amides; polyamides; polyhydroxyalkanoates; polyethyleneterephthalates; polybutyleneterephthalates; polyethylenenaphthalenates, or combinations thereof.

6. The method of claim 5 wherein the aliphatic polyester comprises a compound represented by general formula I: 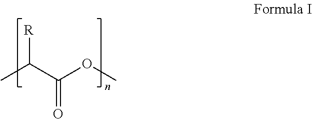
where n is an integer ranging from about 75 to about 10,000 and R comprises hydrogen, an alkyl group, an aryl group, alkylaryl groups, acetyl groups, heteroatoms, or combinations thereof.

7. The method of claim 4 wherein the degradable polymer comprises polylactic acid.

8. The method of claim 1 wherein the expanded diverting material has a porosity of from about 20 vol. % to about 90 vol. %.

9. The method of claim 1 wherein the expanded diverting material has a particle size of from about 0.1 microns to about 5000 microns.

10. The method of claim 1 wherein the compressive strength of the expanded diverting material ranges from about 0.1 psi to about 1,000,000 psi.

11. The method of claim 1 wherein the expanded diverting material has a bulk density of from about 0.05 g/cc to about 1 g/cc.

12. The method of claim 1 wherein the expanded diverting material is present in the wellbore servicing fluid in an amount of from about 0.01 wt. % to about 10 wt. % based on the total weight of the wellbore servicing fluid.

13. The method of claim 1 wherein the second wellbore servicing fluid comprises a fracturing fluid.

14. The method of claim 1 further comprising degrading the expanded diverting material.

15. The method of claim 14 wherein the expanded diverting material is degraded by contact with a degradation agent.

16. The method of claim 15 wherein the degradation agent comprises a base solution, an ammonium hydroxide solution, an alcoholic alkaline solution, an alkaline amine solution, a water-soluble amine, an alkanolamine, a secondary amine, a tertiary amine, oligomers of aziridine, derivatives thereof, or combinations thereof.

17. A wellbore servicing fluid comprising:
a diverting material comprising an expanded polylactide.

18. The wellbore servicing fluid of claim 17 wherein the expanded polylactide is contacted with a degradation agent comprising an alkaline amine solution.

19. A method of servicing a wellbore in a subterranean formation comprising:
placing a wellbore servicing fluid into the subterranean formation at a first location;
plugging the first location with a expanded diverting material such that all or a portion of the wellbore servicing fluid is diverted to a second location in the subterranean formation;
placing the wellbore servicing fluid into the subterranean formation at the second location; and
allowing the expanded diverting material to degrade to provide a flowpath from the subterranean formation to the wellbore for recovery of resources from the subterranean formation.

20. The method of claim 19 wherein the wellbore servicing fluid is a fracturing fluid and the subterranean formation is fractured thereby at the first and second locations.
